(19) United States
(12) Patent Application Publication
(10) Pub. No.: US 2008/0252627 A1
(43) Pub. Date: Oct. 16, 2008

(54) DISPLAY ARRAY DRIVING CIRCUIT AND DRIVING METHOD THEREOF

(75) Inventors: Yong-Nien Rao, Hsinchu City (TW); Cheng-Nan Lin, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RAYDIUM SEMICONDUCTOR CORPORATION, Hsinchu (TW)

(21) Appl. No.: 12/101,222

(22) Filed: Apr. 11, 2008

(30) Foreign Application Priority Data
Apr. 12, 2007 (TW) 96112859

(51) Int. Cl. G09G 5/00

(52) U.S. Cl. 345/204

(57) ABSTRACT

A display array driving circuit is provided. The circuit includes a first memory block, a second memory block, and a main circuit. The first memory block stores the most significant bit (MSB) of the data of one pixel. The second memory block is utilized to store non-MSB bits of the data of the pixel. The main circuit retrieves the MSB of the data of the pixel from the first memory block when the display array is in a predetermined mode, for displaying the pixel data on the display array. In the predetermined mode, the main circuit does not retrieve the non-MSB bits of the data of the pixel, and power consumption is subsequently reduced.

### BACKGROUND OF THE INVENTION

1. Field of the Invention

The invention relates to a display array driving circuit and more particularly to a display array driving circuit capable of reducing power consumption.

2. Description of the Related Art

At present, liquid crystal display (LCD) devices applied in portable electronic apparatuses are thin-film transistor (TFT) LCD devices or super twisted nematic (STN) LCD devices, both of which require memory for saving programs or displaying data. A battery is required for storing program and display data in the memory.

The memory is typically a six-transistor static random access memory (6T-SRAM) or single transistor random access memory (1T-RAM). 6T-SRAM is broadly adopted due to the speed and the logic process compatibility, but SRAM layout area additionally dominates the available chip area. Although 1T-RAM has a layout area smaller than 6T-SRAM, a periodic refresh operation to maintain data in the capacitor may require significant power consumption.

FIG. 1 is a diagram illustrating a memory 10 of an LCD device storing the display data therein according to the related art. Referring to FIG. 1, the memory 10 stores pixel data to be displayed sequentially, such as R0, R1 . . . G0, G1 . . . B0, B1 . . . etc, wherein R (red), G (green), and B (blue) represent the three primary colors of one pixel, and each primary color is represented by 6-bits of data, i.e., the data of one pixel may be represented by R0˜R5, G0˜G5, and B0˜B5. When the LCD device operates in a predetermined mode, for example, an idle mode or a sleep mode, only R5, G5, and B5 of the data of the pixel are required for display. Thus, the extra power is consumed in maintaining the validity of other pixel data not required for display.

Thus, a memory integrating 6T-SRAM and 1T-RAM therein, for improving display efficiency, reducing power consumption, and extending the life of portable electronic apparatuses, is desirable.

### BRIEF SUMMARY OF THE INVENTION

A detailed description is given in the following embodiments with reference to the accompanying drawings. A display array driving circuit capable of reducing power consumption and driving method thereof are provided. An embodiment of a display array driving circuit comprises a first memory block, a second memory block, and a main circuit. The first memory block is utilized to store the most significant bit (MSB) of the data of one pixel. The second memory block is utilized to store non-MSB bits of the data of the pixel. Furthermore, the main circuit retrieves the MSB of the data of the pixel from the first memory block when the display array operates in a predetermined mode and displays the retrieved MSB data on a display array. Moreover, the main circuit stops maintaining the data stored in the second memory block. Reduced power consumption is accordingly achieved. When the display array operates in a normal mode, the main circuit respectively retrieves the data of the pixel from the first memory block and the second memory block, and then displays the retrieved data on the display array. The predetermined mode may be an idle mode or a sleep mode. An embodiment of the second memory block may be a six-transistor static random access memory (6T-SRAM), and the main circuit may cut off or attenuate the power of the second memory block when the display array operates in the predetermined mode. Another embodiment of the second memory block may be a single transistor random, access memory (1T-RAM), and the main circuit stops refreshing the data stored in the second memory block when the display array operates in the predetermined mode, thus data of the second memory block is no longer maintained.

Note that the described first memory block and the second memory block may be integrated in a single memory unit. Additionally, the first memory block and the second memory block may be located in a first memory unit and a second memory unit respectively.

An embodiment of a method of driving a display array for a display array driving circuit, for reducing power consumption of a display, comprises the step of providing a first memory block for storing the most significant bit (MSB) of the data of one pixel for display. A second memory block is then provided to store non-MSB bits of the data of the pixel. The main circuit retrieves the data of the pixel stored in the first memory block and the second memory block according to the result of determining the operating mode of the display array. When the display array operates in a predetermined mode, the main circuit retrieves the data of the pixel of the first memory block, and subsequently presents the pixel data on the display array. At the same time the method stops maintaining the data stored in the second memory block. The predetermined mode may be an idle mode or a sleep mode. Further, when the display array operates in a normal mode, the main circuit retrieves the data of the pixel of the first memory block and the second memory block respectively and subsequently presents the pixel data on the display array. The method further comprises the step of maintaining the MSB data stored in the first memory block via the main circuit, when the display array operates in the predetermined mode.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a diagram illustrating a memory of an LCD device storing the display data therein according to the related art;

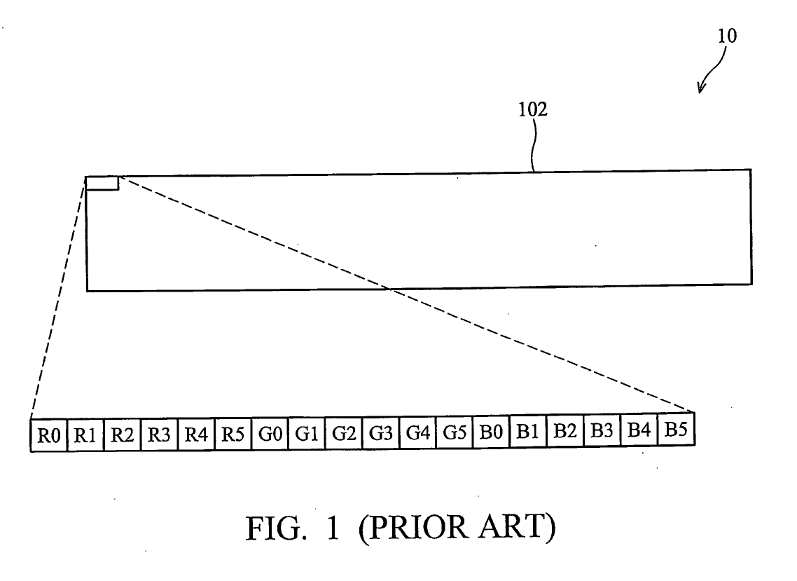

FIG. 2 is a schematic view of an embodiment of a display array driving circuit;

FIG. 3 is a detailed diagram illustrating an embodiment of the first memory block and the second memory block for storing the display data in FIG. 2; and

FIG. 4 is a flowchart of an embodiment of a display array driving method.

### DETAILED DESCRIPTION OF THE INVENTION

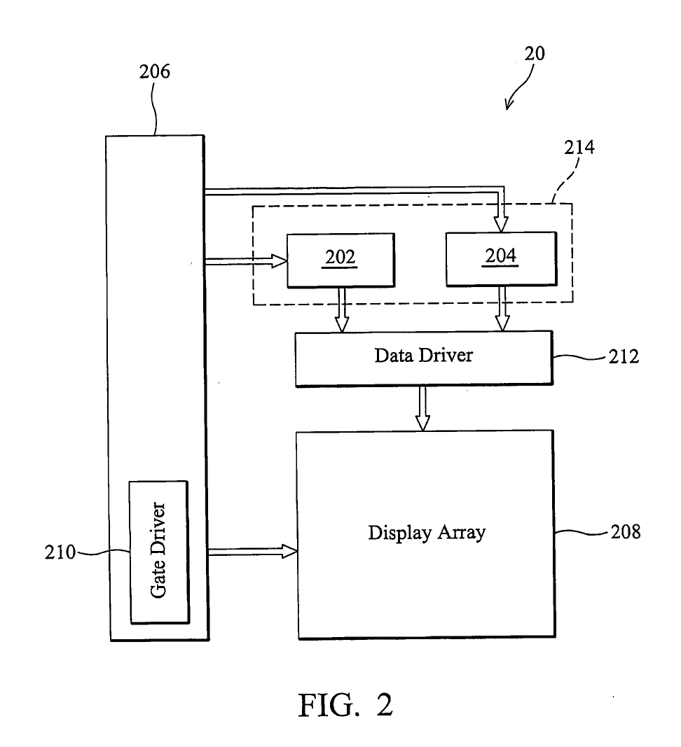

The following exemplary embodiments of the invention are described with reference to FIGS. 2 through 4, which relate to a display array driving circuit and driving method thereof. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention relates to a display array driving circuit, which reduces power consumption and a method for driving the display array.

FIG. 2 is a schematic view of an embodiment of a display array driving circuit. Referring to FIG. 2, the display array driving circuit 20 for driving a display array 208 comprises a first memory block 202, a second memory block 204, and a main circuit 206. An embodiment of the main circuit 206 comprises a gate driver 210 providing a plurality of scan signals to scan the display array sequentially. Another embodiment of the display array driving circuit 20 may comprise a data driver 212 receiving the data of the pixel corresponding to the scan operation of the gate driver 210 to drive the display array 208.

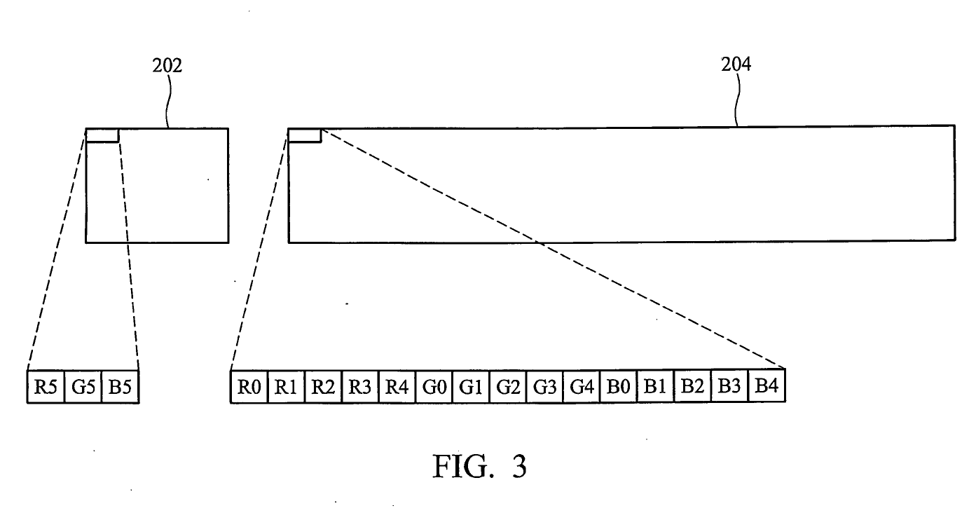

Referring to FIG. 3, which is a detailed diagram illustrating an embodiment of the first memory block 202 and the second memory block 204 shown in FIG. 2. In this embodiment, each pixel in an image comprises 18 bits of pixel data, which is represented by the three primary colors including 6-bits of R (red), G (green), and B (blue) respectively. As shown in FIG. 3, the first memory block 202 is utilized to store the MSB of the data of the pixel, for example, R5, G5, and B5. The second memory block 204 is utilized to store non-MSB bits of the data of the pixel, for example, R0˜R4, G0˜G4, and B0˜B4. When the display array 208 operates in a predetermined mode, the main circuit 206 retrieves the MSB of the data of the pixel, i.e., R5, B5, and G5, from the first memory block 202. The data driver 212 then displays the retrieved data on the display array 208. It is not necessary to display the non-MSB bits of the data of the pixel in the predetermined mode, for example, thus, an idle period can be entered for a specific time (an idle mode) or a long-term standby (a sleep mode) mode may be entered. The main circuit 206 then stops maintaining the non-MSB bits of data (R0˜R4, G0˜G4, and B0˜B4) stored in the second memory block 204, and the power consumption is accordingly reduced. According to the description, the main circuit 206 only maintains MSB data (R5, G5, and B5) stored in the first memory block 202 in the predetermined mode.

When the display array operates in a normal mode, for example, resuming normal operation, the main circuit 206 retrieves the MSB (R5, B5, and G5) and the non-MSB bits (R0˜R4, G0˜G4, and B0˜B4) of the data of the pixel from the first memory block 202 and the second memory block 204 respectively. The retrieved data is transferred to the data driver 212 and is then displayed on the display array 208 in accordance with the scan operation of the gate driver 210.

Note that an embodiment of the second memory block 204 may be a six-transistor static random access memory (6T-SRAM). Thus, the main circuit 206 cuts off or attenuates the power of the second memory block 204 when the display array 208 operates in the predetermined mode, and thereby stops maintaining the non-MSB bits of the data of the pixel stored in the second memory block 204.

Note that another embodiment of the second memory block 204 may be a single transistor random access memory (1T-RAM). Thus, when the display array 208 operates in the predetermined mode, the main circuit 206 stops the refresh operation of the second memory block 204, in order to stop maintaining the data in the second memory block 204.

Similarly, the first memory block 202 may be 6T-SRAM or 1T-RAM according to requirements. Referring to FIG. 2, in this embodiment, the first memory block 202 and the second memory block 204 are integrated in a single memory unit 214. That is, 6T-SRAM or 1T-RAM may be optionally integrated in the memory unit 214. For example, when the first memory block 292 is 6T-SRAM and the second memory block 204 is 1T-RAM in the memory unit 214, the periodic refresh operation of the second memory block 204 is not required, and moreover, reduces the amount of memory required for storing the non-MSB bits. Significant efficiency and capacity gains are thus achieved.

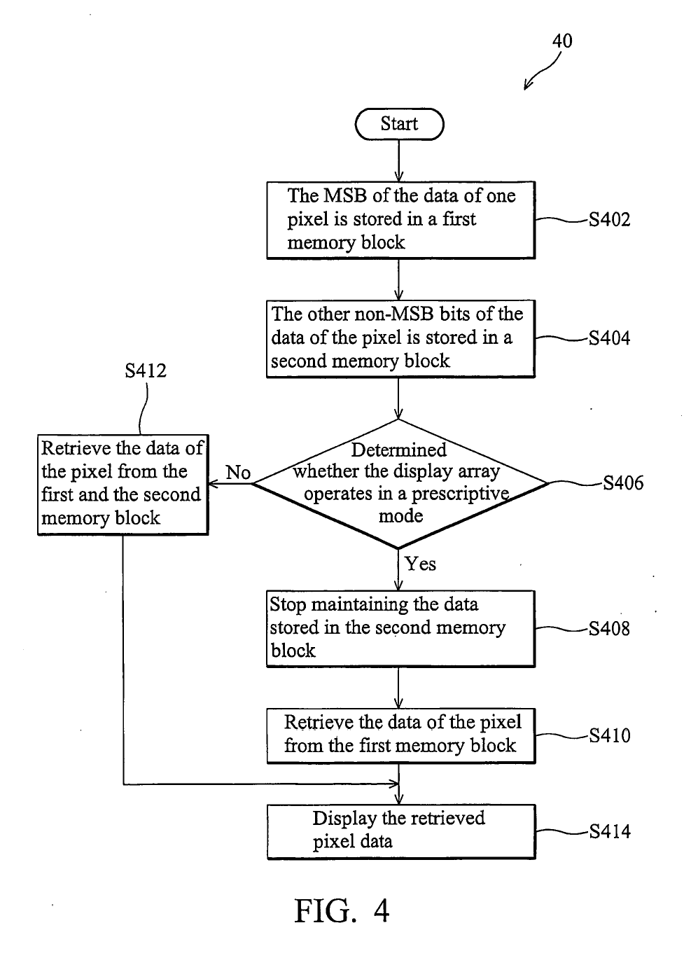

FIG. 4 is a flowchart of an embodiment of a display array driving method. The display driving method 40 is applied in a display array driving circuit (as shown in 20 of FIG. 2), to reduce display power consumption.

In this embodiment, the display array driving circuit may comprise a first memory block and a second memory block. The most significant bit (MSB) of the data of one pixel is first stored in the first memory block (s402), and non-MSB bits of the data of the pixel are further stored in the second memory block (s404). It is subsequently determined whether the display array operates in a predetermined mode (s406). A main circuit stops maintaining the non-MSB bits of data stored in the second memory block (e.g., stop data refreshing) when the display array operates in predetermined mode, for example, an idle mode or a sleep mode (s408). The main circuit retrieves the MSB data from the first memory block (s410), thus, the data in the first memory block is still valid. When the display array operates in a normal mode, the main circuit proceeds to retrieve the data of the pixel from the first memory block and the second memory block respectively (s412). Subsequently, the main circuit displays the retrieved pixel data on the display array (s414).

Note that an embodiment of the second memory block may be a six-transistor static random access memory (6T-SRAM). Thus, the main circuit stops maintaining the data in the second memory block by way of cutting off or attenuating the power provided to the second memory block. Another embodiment of the second memory block may be a single transistor random access memory (1T-RAM), and the main circuit may stop refreshing the second memory block to stop maintaining the data in the second memory block.

In addition, those skilled in the art will recognize that the disclosed first memory block and the second memory block may be integrated in a single memory unit, or optionally be located in a first memory unit and a second memory unit respectively.

While the invention has been described by way of example and in terms of preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display array driving circuit, comprising:
a first memory block, utilized to store the most significant bit (MSB) of the data of one pixel;
a second memory block, utilized to store non-MSB bits of the data of the pixel; and
a main circuit, retrieving the MSB of the data of the pixel from the first memory block when the display array operates in a predetermined mode and stopping maintaining the data stored in the second memory block.

2. The display array driving circuit as claimed in claim 1, wherein the main circuit respectively retrieves the MSB and the non-MSB of the data of the pixel stored in the first memory block and the second memory block when the display array operates in a normal mode.

3. The display array driving circuit as claimed in claim 1, wherein the second memory block is a six-transistor static random access memory (6T-SRAM), and the main circuit attenuates the power of the second memory block when the display array operates in the predetermined mode, to stop maintaining the data stored in the second memory block.

4. The display array driving circuit as claimed in claim 1, wherein the second memory block is a single transistor random access memory (1T-RAM), and the main circuit stops refreshing the data stored in the second memory block when the display array operates in the predetermined mode, to stop maintaining the data stored in the second memory block.

5. The display array driving circuit as claimed in claim 1, wherein the main circuit maintains the MSB data stored in the first memory block when the display array operates in the predetermined mode.

6. The display array driving circuit as claimed in claim 1, wherein the predetermined mode is an idle mode or a sleep mode.

7. The display array driving circuit as claimed in claim 1, further comprising a memory unit integrating the first memory block and the second memory block therein.

8. The display array driving circuit as claimed in claim 1, further comprising a first memory unit and a second memory unit, having the first memory block and the second memory block therein respectively.

9. A method of driving a display array for a display array driving circuit, the method comprising the steps of:
providing a first memory block to store the most significant bit (MSB) of the data of one pixel;
providing a second memory block to store non-MSB bits of the data of the pixel;
determining the operating mode of the display array;
retrieving the MSB of the data of the pixel from the first memory block via a main circuit when the display array operates in a predetermined mode and stopping maintaining the data stored in the second memory block.

10. The method as claimed in claim 9, further comprising:
retrieving the data of the pixel from the first memory block and the second memory block respectively when the display array operates in a normal mode, and displaying the retrieved pixel data on the display array.

11. The method as claimed in claim 9, wherein when the display array operates in the predetermined mode, further comprises the step of:
maintaining the MSB data stored in the first memory block.

12. The method as claimed in claim 9, wherein the step of stopping maintaining the data stored in the second memory block, further comprises:
attenuating the power of the second memory block when the second memory block is a six-transistor static random access memory (6T-SRAM).

13. The method as claimed in claim 9, wherein the step of stopping maintenance of the data stored in the second memory block, further comprises:
stopping refreshing of the data stored in the second memory block when the second memory block is a single transistor random access memory (1T-RAM).

14. The method as claimed in claim 9, wherein the predetermined mode is an idle mode or a sleep mode.

15. The method as claimed in claim 9, wherein the first memory block and the second memory block are integrated into a memory unit, or located in a first memory unit and a second memory unit respectively.
